(19) United States
(12) Patent Application Publication
(10) Pub. No.: US 2025/0228271 A1
(43) Pub. Date: Jul. 17, 2025

(54) Three Dimensional Snack Product

(71) Applicant: Frito-Lay North America, Inc., Plano, TX (US)

(72) Inventors: Ashley Nicole Taylor, Plano, TX (US); Ajay Rajeshwar Bhaskar, Allen, TX (US); Naveen Chikthimmah, Plano, TX (US)

(21) Appl. No.: 18/415,320

(22) Filed: Jan. 17, 2024

(51) Int. Cl. A23L 7/117; A23L 7/196; A23L 19/00; A23L 19/18

(52) U.S. Cl. CPC A23L 7/117; A23L 7/1965; A23L 19/01; A23L 19/18

(57) ABSTRACT

A snack product includes a starch base, vegetable substrate(s) other than potato and corn, whole grain ingredient(s), and optional additives. The snack product provides about 10% or more vegetables and from about 15% to about 45% whole grains and has a bulk density between about 50 g/L to about 84 g/L. An exemplary method of making a snack product includes hydrating a dry mix containing a starch base, vegetable substrate(s) other than potato and corn, whole grain ingredient(s), and optional additives to form a dough containing from about 30% to about 40% moisture. The dough may be extruded through a die slot to form a continuous sheet that may be cut to form individual snack sized pieces, which are then fried pieces to form the snack product.

Methods of making a dry mix for a three dimensional snack product, a dough for forming the three dimensional snack product, and the resulting three dimensional snack product are described. In some aspects, the three dimensional snack product will contain whole grains and vegetables and, in this regard, in some aspects the whole grains may be present in the snack product at a level of 10% or greater and the vegetables may be present in the snack product at a level of about 10% or greater, where the vegetables include, for example, legumes, pulses, and vegetables (i.e., sweet potatoes, (Ipomoea batatas)), other than potatoes (i.e., Solanum tuberosum) and corn.

### BACKGROUND

Increasingly, consumers seek snack products that provide a variety of tastes and textures and may be perceived as “healthy”. To that end, in the field of snack foods there has been a recent focus on producing snack foods that contain whole grains and/or vegetable and/or fruit matter. A challenge to producing snack foods that contain whole grains is that it is difficult to create homogeneous dough sheets from which the snack product may be made. In addition, in some instances, whole grains present organoleptic and sensory challenges due to the characteristic earthy odor and flavor as well as the dense or dry texture imparted by whole grains. In addition to the challenges presented by the use of whole grains, it is known to be difficult to create an organoleptically pleasing product while providing a significant amount of vegetable matter, other than potatoes and corn, for which consumers are abundantly familiar with in the form of potato and corn chips. Thus, there is a need to provide a snack food that contains more than an insignificant amount of whole grains (i.e., at least about 10% whole grains) in combination with real vegetables other than potatoes and corn, i.e., about 10% or greater real vegetables. Moreover, it would be desirable to provide such a snack food as a three dimensional product that evokes a light and airy visual appearance and provides a crispy, crunchy texture.

### SUMMARY

A method of making a three dimensional snack product that contains a significant amount of whole grains and real vegetables and the resulting three dimensional snack product are described. In particular, the following describes a dry mix used to formulate the three dimensional snack product, a dough formed using the dry mix that is further processed to form the three dimensional snack product, the resulting three dimensional snack product, and methods of making each. For ease of description, the three dimensional snack product may simply be referred to as the snack product. The skilled artisan will appreciate that reference to snack product will be intended to refer to the three dimensional snack product shown and described in the following, unless the circumstances dictate otherwise.

It has been found that suitable snack products containing 10% or more vegetables, other than potatoes and corn, and from about 15% to about 45% of whole grains can be made from a dry mix that includes a starch base. In one embodiment, the dry mix may be formed with a minor amount (i.e., less than about 30%) of a starch base and, in another embodiment, the dry mix may be formed with a major amount (greater than about 40%) of a starch base.

In either event, the starch base may then be combined with one or more vegetable substrates as well as one or more whole grains (may also be referred to whole grain ingredient or ingredients). “Whole grain” shall mean that the grain, for example, whole rice flour (brown rice flour) or whole grain corn flour, “consists of the intact, ground, cracked, or flaked or otherwise processed kernel after removal of inedible parts such as the hull and husk [and a]ll anatomical components, including the endosperm, germ, and bran . . . [are] present in the same relative proportions as the intact kernel.” (See, https://www.wholegraininitiative.org/media/attachments/2022/01/21/adapted-2021-03-17-definition-of-whole-grain-as-food-ingredient-proposed-by-global-working-group_update2022.pdf (last accessed Dec. 4, 2023).)

In some instances, the vegetable substrate may be free of potatoes and/or corn. That being said, it is contemplated that the snack product may contain potato ingredients as part of the starch base and may contain whole grain corn flour as part of the whole grain ingredients and yet, the vegetable substrate may be free of potatoes and/or corn. Put another way, when the amount of vegetable present in the snack product is being described as being at least 10% or more, that amount does not include any potato or corn that may be present as part of the starch base or the whole grain, respectively.

To that end, as used in this description, reference to vegetables (vegetable substrates) and amounts of vegetables refers to amounts of vegetables other than potatoes and corn, i.e., reference to vegetable is specifically meant to exclude potato and corn. More particularly, reference to potato (or potatoes) refers to the tubers of the plant Solanum tuberosum and, as such, reference to vegetable does not exclude sweet potatoes, which are in fact, not potatoes since they are from the species Ipomoea batatas. In other words, while the dry mix, dough, and/or resulting snack product may contain some form of potato or corn, the described dry mix, dough, and snack product, contain less than 100% of potato and potato-based ingredients and, in some instances, less than about 70% of potato and potato-based ingredients such as potato flour, dried potatoes, potato starch, or other potato or potato-based ingredients. Similarly, while the described dry mix, dough, and snack product may contain some form of corn, e.g., corn flour, the dry mix, dough, and snack product contain less than 100% corn and corn-based ingredients and, in some instances less than about 20%, or in some instances less than about 15% of corn and corn-based ingredients such as corn flour.

The vegetable (vegetable substrate) may be provided as a whole vegetable flour and may be from any suitable vegetable flour (other than potato and corn) and, in some instances, may be free of decorticated (e.g., dehulled) flours. In this regard, the use of a whole vegetable flour as compared to decorticated vegetable flours may be more nutritionally desirable since they may contain a higher fiber content, beneficial vitamins, and/or bioactive components. In addition, it has been found that the use of pre-cooked (pre-gel) whole vegetable flours may not lead to desirable extruded sheets. Accordingly, the described dry mix, doughs, and the snack product are free of pre-cooked (pre-gelled) whole vegetable flours.

The dry mix may also contain minor amounts (less than about 4% individually) of additive ingredients such as flavorings, colorants, processing aids, emulsifiers, oils, and the like.

The dry mix may be preconditioned by hydrating the dry mix with moisture to form a dough containing from about 30% to about 40% moisture. Following preconditioning, the dough may be extruded to form an extruded sheet having a thickness in the range of about 0.5 mm to about 3.0 mm.

The extruded sheet may then be optionally perforated and thereafter, tempered to a temperature in a range of about 25° C. to about 35° C., after which the extruded sheet may be joined with one or more similar extruded sheets. The joined sheets may then be cut, which may form individual snack-sized pieces and/or clusters of individual snack-sized pieces.

The individual snack-sized pieces are dehydrated such as by drying in any suitable manner to achieve a moisture content of about 8% to about 15%. Thereafter, the dried individual snack-sized pieces and/or clusters of individual snack-sized pieces are fried, causing the joined sheets that formed the individual snack-sized pieces to expand and form a three-dimensional shape which, if the extruded sheet has been perforated, will contain perforations.

It is contemplated that the formed three-dimensional snack product may include two or more layers, (e.g., two, three, four, etc). Additionally or alternatively, one or more or all of the layers may include perforations (i.e., holes passing through one or more of the layers).

In general, the snack product may include from about 10% to about 40% of a starch base, from about 5% to about 20% of vegetable substrate(s), from about 10% to about 45% whole grain ingredient(s), with a moisture content between about 1% to about 4%.

In one embodiment, the resulting snack product in an unseasoned state (i.e., does not contain an applied seasoning such as, but not limited to a topical seasoning) may contain from about 30% to about 40% of a starch base, from about 5% to about 20% whole vegetable flour or powder (where the vegetable flour or powder is from a source other than potato or corn), from about 10% to about 30% whole grain ingredient(s), with a moisture content between about 1% to about 4%. It is also contemplated that the snack product may contain one or more natural colorants such as turmeric extract, annatto extract, beet powder, tomato powder, spinach powder, kale powder, broccoli powder, and/or carrot powder as well as minor amounts of flavorants and/or processing aids.

In another embodiment, the resulting snack product in an unseasoned state (i.e., does not contain an applied seasoning such as, but not limited to, a topical seasoning) may contain from about 10% to about 25% of a starch base, from about 5% to about 20% whole vegetable flour or powder (where the vegetable flour or powder is from a source other than potato or corn), from about 35% to about 45% whole grain ingredient(s) flour, with a moisture content between about 1% to about 4%. It is also contemplated that the snack product may contain one or more natural colorants such as turmeric extract, annatto extract, beet powder, tomato powder, spinach powder, kale powder, broccoli powder, and/or carrot powder as well as minor amounts of flavorants and/or processing aids.

In either embodiment, the snack product may contain from about 10 to about 30 grams of whole grains in 100 grams of the snack product and from about 5 to about 20 grams of vegetables, other than potatoes and corn. As noted above, in some instances, the resulting snack product may contain at least about 10% real vegetables, other than potatoes and corn. As used in the description and claims, the phrase “real vegetables” refers to vegetables other than potatoes and corn and refers to vegetables in a dried, powdered, and particulate state such as, for example, flour. With this in mind, the phrase “real vegetables” is intended to exclude whole, cut, diced, raw, cooked, or dried vegetables having a particle size greater than about 500 μm.

It is contemplated that the resulting snack product may be flavored by applying, topically or otherwise, one or more seasonings to the snack product in any known manner. When applied, the seasoning or seasonings may comprise from about 0.5% to about 10%, in the aggregate, of the snack product.

The snack product may have a bulk density between about 50 g/L to about 84 g/L. In some embodiments such as in an unseasoned state, i.e., after creation of the snack product and prior to the application of seasoning, the snack product may have a bulk density between about 50 g/L to about 72 g/L. In other aspects, a seasoned three dimensional snack product may have a bulk density between about 50 g/L to about 84 g/L. In addition, it will be appreciated and it is contemplated that because the described snack product is formulated to have a bulk density within the range of about between about 50 g/L to about 84 g/L, it may be free of and may not contain pieces or particles of vegetable (or fruit), whether fresh, dehydrated, or present in some other form other than flours or powders. Moreover, advantageously, the desired bulk density is achieved in the absence of any leavening agents and, as such, it is contemplated that the described dry mix, dough, and snack product are free of leavening agents.

In one aspect, it is contemplated to provide a package that contains a variety of the described snack products to provide a pleasing multi-colored snack product in a single package while providing a significant amount of whole grains and real vegetables. For example, a single package may contain a plurality of yellow or natural colored snack products, green colored snack products and orange, orange-red, or red colored snack products. It is also contemplated that the package may contain other colored snack products. Of course, a single package may contain a single color of the snack product.

Additionally, it is contemplated that the described dry mix, dough and snack product may be free of gluten and/or gluten-containing substances, exogenous fibers, and exogenous proteins. Exogenous fiber refers to fiber that is added to the dry mix or dough in contrast to fiber that that is naturally present in the ingredients forming the described dry mix, dough, and snack product, which is considered to be intrinsic (or endogenous) fiber. Examples of exogenous fiber may be inulin and polydextrose, which in some instances are excluded from the described dry mix, dough, and snack product. Similarly, it is contemplated that the described dough and snack product may be free of exogenous protein. Exogenous protein refers to protein that is added to the dough in contrast to protein that that is naturally present in ingredients forming the described dry mix, dough, and snack product, which is considered to be intrinsic (or endogenous) protein. An example of exogenous protein is albumin.

All percentages recited above and in the following description and claims are percent by weight unless specifically noted otherwise. Other aspects and advantages of this invention will be appreciated from the following detailed description.

### BRIEF DESCRIPTION OF THE DRAWINGS

FIG. 1 illustrates one method of preparing a snack product and particularly a three dimensional snack product according to the described embodiments.

FIG. 2 is a view of a perspective view of an exemplary three dimensional snack product made according to the described methods.

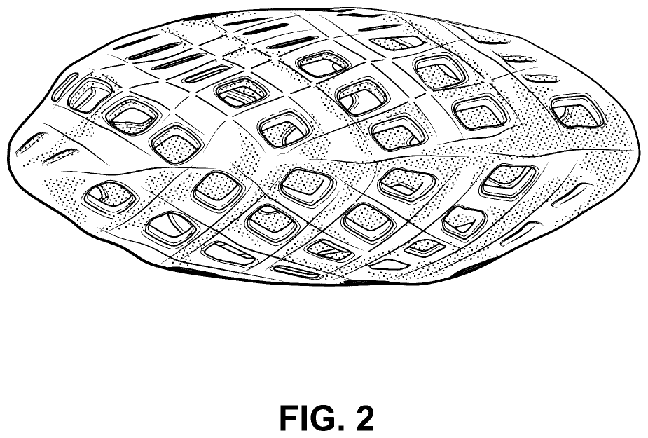

### DETAILED DESCRIPTION OF THE INVENTION

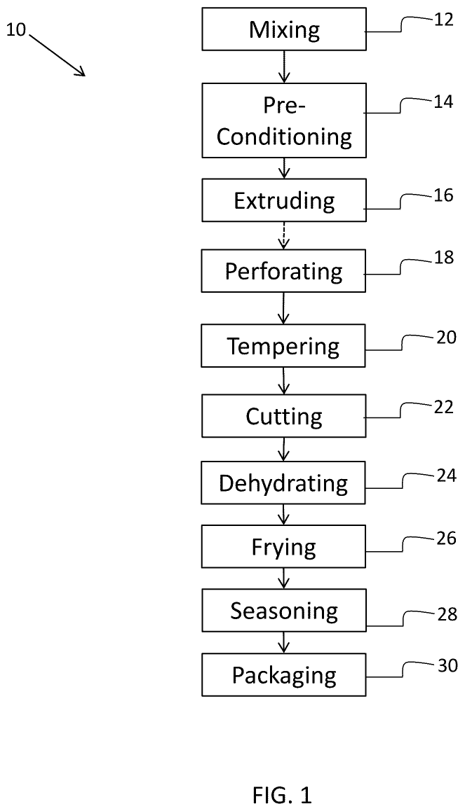

Referring to FIG. 1, an exemplary method 10 for preparing a snack product is shown. The method 10 includes mixing 12 a plurality of dry ingredients to provide a dry mix. The dry mix can then be pre-conditioned 14 such as by adding water in the absence of steam injection or heat to provide dough having a moisture content between about 30% to about 40%. The dough may then be extruded 16 in a known manner to form an extruded sheet having a thickness in the range of about 0.5 mm to about 3.0 mm. In some instances, the extruded sheet may be perforated 18 and thereafter tempered 20 and cut 22 to form individual snack-sized pieces and clusters of individual snack-sized pieces that are then dehydrated 24 and thereafter fried 26 to produce the snack product. The snack product may then be seasoned 28 and then packaged 30.

As noted above, the dry mix may include from about 15% to about 60% of a starch base ingredient, from about 5% to about 25% of one or more vegetable substrates (where the vegetable substrate is from a source other than potato or corn), from about 10% to about 60% of one or more whole grain ingredients, and minor amounts of additives such as colorants and flavorants.

### Starch Base

As noted above, in one embodiment, the starch base is present in the dry mix in amounts of 30% or less (may be referred to as minor-starch formulation) and in another embodiment, the starch base is present in the dry mix in amounts of 40% or greater (may be referred to as major-starch formulation).

### Minor-Starch Formulation

In this embodiment, the starch base present in the dry mix may include any suitable starch or combination of starch so long as it does not include gluten. With that in mind, however, it has been found that a suitable product can be formed when the starch base includes potato and potato-based ingredients such as potato flour, dried potatoes, potato starch, or other potato or potato-based ingredients alone or in combination with tapioca starch and/or corn starch. The dry mix may include 30% or less of the starch base. In this regard, the starch base may be present in the dry mix in amounts from about 10% to about 30% of a starch base ingredient (potato starch alone or in combination with tapioca starch and/or corn starch), or about 10%, 11%, 12%, 13%, 14%, 15%, 16%, 17%, 18%, 19%, 20%, 21%, 22%, 23%, 24%, 25%, 26%, 27%, 28%, 29%, or about 30%. In some aspects, the starch base ingredient may be present in the dry mix in a range where the lower limit may be from any one of about 10%, 11%, 12%, 13%, 14%, 15%, 16%, 17%, 18%, 19%, 20%, 21%, 22%, 23%, 24%, 25%, 26%, 27%, 28%, or about 29%, while the upper limit may be from any one of about 11%, 12%, 13%, 14%, 15%, 16%, 17%, 18%, 19%, 20%, 21%, 22%, 23%, 24%, 25%, 26%, 27%, 28%, 29%, or about 30%.

In some aspects, the starch base comprises, consists essentially of, or consists of a mixture of potato starch and one of tapioca starch or corn starch. The potato starch and either the tapioca starch or corn starch may be present in the dry mix in a ratio of about 1:1 to about 3:1 or about 2:1. To this end, the potato starch may be included in the dry mix in amounts ranging from about 10% to about 20%, or about 10%, 11%, 12%, 13%, 14%, 15%, 16%, 17%, 18%, 19%, or about 20%. In some embodiments, the potato starch may be present in the dry mix in a range where the lower limit may be from any one of about 10%, 11%, 12%, 13%, 14%, 15%, 16%, 17%, 18%, or about 19%, while the upper limit may be from any one of about 11%, 12%, 13%, 14%, 15%, 16%, 17%, 18%, 19%, or about 20%. Also, in these aspects, the tapioca starch or the corn starch may be included in the dry mix in amounts ranging from about 1% to about 15%, or about 1%, 2%, 3%, 4%, 5%, 6%, 7%, 8%, 9%, 10%, 11%, 12%, 13%, 14%, or about 15%. In some embodiments, tapioca starch or the corn starch may be present in the dry mix in a range where the lower limit may be from any one of about 1%, 2%, 3%, 4%, 5%, 6%, 7%, 8%, 9%, 10%, 11%, 12%, 13%, or about 14%, while the upper limit may be from any one of about 2%, 3,%, 4%, 5%, 6%, 7%, 8%, 9%, 10%, 11%, 12%, 13%, 14%, or about 15%.

In some aspects, the starch base comprises, consists essentially of, or consists of a mixture of potato starch, tapioca starch, and corn starch. The potato starch and the tapioca starch may be present in the dry mix in a ratio of about 1:1. To this end, the potato starch and tapioca starch may be included in the dry mix in amounts ranging from about 10% to about 20%, or about 10%, 11%, 12%, 13%, 14%, 15%, 16%, 17%, 18%, 19%, or about 20%. In some embodiments, the potato starch and the tapioca starch may be present in the dry mix in a range where the lower limit may be from any one of about 10%, 11%, 12%, 13%, 14%, 15%, 16%, 17%, 18%, or about 19%, while the upper limit may be from any one of about 11%, 12%, 13%, 14%, 15%, 16%, 17%, 18%, 19%, or about 20%. Also, in these aspects, the corn starch may be included in the dry mix in amounts such that a ratio of potato starch to tapioca starch to corn starch is about 1:1:0.67. To that end, the corn starch may be provided in the dry mix in amounts ranging from about 5% to about 15%, or about 5%, 6%, 7%, 8%, 9%, 10%, 11%, 12%, 13%, 14%, or about 15%. In some embodiments, the corn starch may be present in the dry mix in a range where the lower limit may be from any one of about 5%, 6%, 7%, 8%, 9%, 10%, 11%, 12%, 13%, or about 14%, while the upper limit may be from any one of about 6%, 7%, 8%, 9%, 10%, 11%, 12%, 13%, 14%, or about 15%.

### Major-Starch Formulation

In this embodiment, the starch base present in the dry mix may include any suitable starch or combination of starch so long as it does not include gluten. With that in mind, however, it has been found that a suitable product can be formed when the starch base includes only potato and potato-based ingredients such as potato flour, dried potatoes, potato starch, or other potato or potato-based ingredients. In other words, in this embodiment, it is contemplated that in some aspects, the starch base is free of tapioca starch, corn starch, or starches other than potato starch. Accordingly, in this embodiment, the dry mix may include 40% or more of the starch base. In this regard, the starch base may be present in the dry mix in amounts from about 40% to about 60% of a starch base ingredient (in some instances, only potato starch), or about 40%, 41%, 42%, 43%, 44%, 45%, 46%, 47%, 48%, 49%, 50%, 51%, 52%, 53%, 54%, 55%, 56%, 57%, 58%, 59%, or about 60%. In some aspects, the starch base ingredient may be present in the dry mix in a range where the lower limit may be from any one of about 40%, 41%, 42%, 43%, 44%, 45%, 46%, 47%, 48%, 49%, 50%, 51%, 52%, 53%, 54%, 55%, 56%, 57%, 58%, or about 59%, while the upper limit may be from any one of about 41%, 42%, 43%, 44%, 45%, 46%, 47%, 48%, 49%, 50%, 51%, 52%, 53%, 54%, 55%, 56%, 57%, 58%, 59%, or about 60%.

### Vegetable Substrate

As noted above, the vegetable substrate(s) is provided as particulates such as a flour, powder, or a mixture of a flour and a powder and not as raw, cooked, partially cooked pieces. For ease of description, the vegetable substrate may be referred to as a vegetable flour, although it will be appreciated that it may be provided as a powder or a mixture of a flour and a powder.

In this instance, the vegetable flour is typically provided as a whole vegetable flour from real vegetable flours selected from legumes, pulses, and vegetables other than potatoes and corn. To that end, as used in this description, reference to vegetables and amounts of vegetables refers to amounts of vegetables other than potatoes and corn, i.e., reference to vegetable is specifically meant to exclude potato and corn. In other words, while the snack product may contain some form of potato and/or corn, the described dough and snack product contains less than 100% of potato and potato-based ingredients and, in some instances, less than about 70% of potato and potato-based ingredients such as, but not limited to, potato flour, dried potatoes, potato starch, or other potato or potato-based ingredients.

Similarly, while the snack product may contain some form of corn, the described dough and snack product contains less than 100% or less than 70% of corn and corn-based ingredients and, in some instances, less than 20% of corn and corn-based ingredients such as corn flour.

The vegetable flour may be from any suitable vegetable flour and, in some instances, is free of decorticated (e.g., dehulled) flours. In this regard, the use of a whole vegetable flour as compared to a decorticated vegetable flours may be more nutritionally desirable since it may contain a higher fiber content, beneficial vitamins and/or bioactive components. In addition, it has been found that the use of pre-cooked (pre-gel) whole vegetable flours do not lead to desirable extruded sheets and thus, leads to undesirable snack products. Accordingly, the described doughs and the snack product, are free of pre-cooked (pre-gel) vegetable flours.

The vegetable flour may be provided by one or more of legumes, pulses, and vegetables other than potatoes and corn. Exemplary but not limiting legumes may include but may not be limited to chickpeas, black beans, green peas, yellow peas, lima beans, kidney beans, black-eyed peas, and navy beans. Exemplary but not limiting pulses may include but may not be limited to lentils, fava beans, Bambara beans, pigeon peas, lupins, and vetches. Exemplary but not limiting vegetables other than potatoes and corn may include but may not be limited to carrot, peppers (e.g., green peppers, red peppers, etc.), beets, yams, sweet potatoes, broccoli, pumpkin, squash, tomato, celery, spinach, zucchini, cucumber, cauliflower, onion, scallion, asparagus, garlic, etc.

The vegetable flour may be present in the dry mix in an amount of 10% or greater. In that regard, the vegetable flour may be present in the dry mix in an amount from about 5% to about 25%, or about 5%, 6%, 7%, 8%, 9%, 10%, 11%, 12%, 13%, 14%, 15%, 16%, 17%, 18%, 19%, 20%, 21%, 22%, 23%, 24%, or about 25%. In some aspects, the vegetable flour may be present in the dry mix in a range where the lower limit may be from any one of about 5%, 6%, 7%, 8%, 9%, 10%, 11%, 12%, 13%, 14%, 15%, 16%, 17%, 18%, 19%, 20%, 21%, 22%, 23%, or about 24%, while the upper limit may be from any one of about or about 6%, 7%, 8%, 9%, 10%, 11%, 12%, 13%, 14%, 15%, 16%, 17%, 18%, 19%, 20%, 21%, 22%, 23%, 24%, or about 25%.

### Whole Grains

As noted above, the dry mix includes from about 10% to about 60% of one or more whole grain ingredients. And, as explained above “whole grain” means that the grain, for example, whole rice flour (brown rice flour) or whole grain corn flour, “consists of the intact, ground, cracked, or flaked or otherwise processed kernel after removal of inedible parts such as the hull and husk [and a]ll anatomical components, including the endosperm, germ, and bran . . . [are] present in the same relative proportions as the intact kernel.” (See, https://www.wholegraininitiative.org/media/attachments/2022/01/21/adapted-2021-03-17-definition-of-whole-grain-as-food-ingredient-proposed-by-global-working-group_update2022.pdf (last accessed Dec. 4, 2023).)

The whole grain ingredient may be any suitable whole grain ingredient so long as the whole grain ingredient does not contain gluten. As such, the dry mix, dough, and resulting snack product are free of gluten. In some instances, the whole grain ingredients may include whole rice flour (also known as whole brown rice flour) alone or in combination with whole corn flour. In other instances, the whole grain ingredient may comprise, consist essentially of, or consist of whole rice flour alone or in combination with whole corn flour.

Where the dry mix is formed using the minor-starch formulation, the whole grain ingredient(s) may be present in the dry mix in an amount from about 40% to about 60%. In this regard, the dry mix may include whole rice flour in an amount of about 40%, 41%, 42%, 43%, 44%, 45%, 46%, 47%, 48%, 49%, 50%, 51%, 52%, 53%, 54%, 55%, 56%, 57%, 58%, 59%, or about 60%. In some aspects, the whole rice flour may be present in the dry mix in a range where the lower limit may be from any one of about 40%, 41%, 42%, 43%, 44%, 45%, 46%, 47%, 48%, 49%, 50%, 51%, 52%, 53%, 54%, 55%, 56%, 57%, 58%, or about 59%, while the upper limit may be from any one of about 41%, 42%, 43%, 44%, 45%, 46%, 47%, 48%, 49%, 50%, 51%, 52%, 53%, 54%, 55%, 56%, 57%, 58%, 59%, or about 60%.

Where whole rice flour is used in combination with whole corn flour and where the dry mix is formed using the minor-starch formulation, the whole corn flour may be present in the dry mix in an amount from about 1% to about 10%. In this regard, the dry mix may include the whole corn flour in an amount from about 1%, 2%, 3%, 4%, 5%, 6%, 7%, 8%, 9%, or about 10%. In some aspects, the whole corn flour may be present in the dry mix in a range where the lower limit may be from any one of about 1%, 2%, 3%, 4%, 5%, 6%, 7%, 8%, or about 9%, while the upper limit may be from any one of about 2%, 3%, 4%, 5%, 6%, 7%, 8%, 9%, or about 10%. Generally, the whole corn flour, when used may be used in amounts such that the ratio of whole rice flour to whole corn flour is from about 7:1 to about 9:1 or about 8:1.

When the dry mix is formulated with the major starch base formulation, the whole grain ingredient(s) may be present in the dry mix in an amount from about 10% to about 30%. In one embodiment the whole grain ingredient(s) may comprise, consist essentially of, or consist of whole rice flour and whole corn flour. To this end, the whole rice flour may be present in the dry mix in an amount from about 10% to about 20%. In this regard, the dry mix may include whole rice flour in an amount of about 10%, 11%, 12%, 13%, 14%, 15%, 16%, 17%, 18%, 19%, or about 20%. In some aspects, the whole rice flour may be present in the dry mix in a range where the lower limit may be from any one of about 10%, 11%, 12%, 13%, 14%, 15%, 16%, 17%, 18%, or about 19%, while the upper limit may be from any one of about 11%, 12%, 13%, 14%, 15%, 16%, 17%, 18%, 19%, or about 20%.

And, the whole corn flour present may be present in the dry mix in an amount from about 10% to about 20%. In this regard, the dry mix may include whole corn flour in an amount of about 10%, 11%, 12%, 13%, 14%, 15%, 16%, 17%, 18%, 19%, or about 20%. In some aspects, the whole corn flour may be present in the dry mix in a range where the lower limit may be from any one of about 10%, 11%, 12%, 13%, 14%, 15%, 16%, 17%, 18%, or about 19%, while the upper limit may be from any one of about 11%, 12%, 13%, 14%, 15%, 16%, 17%, 18%, 19%, or about 20%. In some instances, the whole rice four and whole corn flour may be provided in equal amounts, i.e., the ratio of whole rice flour and whole corn flour is about 1:1.

### Additives

It is contemplated that additives may be included in the dry mix and/or the dough for suitable purposes such as, but not limited to, processing aids, flavorants, colorants, and the like. Where additives are included in the dry mix, each may be present in individual amounts from about 0.05% to about 5%.

Exemplary additives include, but are not limited to sugar, salt, flavorants, oils, fats, emulsifiers, colorants and the like. Regarding colorants, the dry mix may contain one or more colorants that may contribute to the resulting color and flavor of the resulting base flavor. In some instances, the colorant may be a vegetable powder other than the vegetable substrate noted above and may be selected from any one or more of, but not limited to, turmeric, beet, tomato, spinach, kale, broccoli, carrot, sweet potato, peppers (yellow, green, and red bell peppers, jalapeno, etc.), squash, cauliflower, beans (green, navy, fava), and peas. Depending on the desired color of the snack product, the vegetable powder may be selected from one or more of tomato, beet, spinach, or kale.

The vegetable powder or powders, when present may be included in the dry mix in amounts, individually or collectively, from about 0.2% to about 5.0%. In some aspects, the vegetable powder or powders, individually or collectively, may be present in the dry mix in a range where the lower limit may be from any one of about 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, or about 4.9%, while the upper limit may be from any one of about 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, or about 5.0%.

While the above vegetable powders may impart color to the resulting snack product, it is nevertheless contemplated that additional coloring may be desired or that other natural colorants may be used in place of the above vegetable powders. Where natural colorants are used instead of vegetable powders, it is contemplated that the dry mix (and thus the resulting dough and snack product) is free of vegetable powders (except of course where provided as the vegetable substrate). In such instances, it is desired to use natural colorants and to exclude artificial colorants. Natural colorants may include turmeric extract to provide a yellow color or annatto extract to provide a red color. Other natural colorants may be known by the skilled artisan and, as such, are contemplated for inclusion within the dry mix.

When natural colorants are included in the dry mix, they may be present individually or collectively in amounts from about 0.01% to about 1%, or from about 0.02, %, 0.03%, 0.04%, 0.05%, 0.06%, 0.07%, 0.08%, 0.09%, 0.1%, 0.2%, 0.3%, 0.4%, 0.5%, 0.6%, 0.7%, 0.8% 0.09%, or about 1%.

Each of the ingredients forming the dry mix may be combined in any known manner to provide an intimate mixture of the ingredients.

### Dough

After the dry mix is prepared by mixing the above ingredients, the dry mix may be preconditioned by adding a sufficient amount of moisture at ambient temperature (about 72° F. to about 80° F.), typically by spraying the water into a rotating bed of the dry mix to form a dough. In some instances, the preconditioning is conducted in the absence of steam or applied heat since it is believed that higher temperatures may deleteriously affect one or more of the ingredients forming the dry mix.

The resulting dough will contain from about 60% to 70% of the above-described dry mix, with the remaining balance being added water or moisture. In this regard, the dough may contain dry mix in an amount from about 60%, 60.5%, 61%, 61.5%, 62%, 62.5%, 63%, 63.5,%, 64%, 64.5%, 65%, 65.5%, 66%, 66.5%, 67% 67.5%, 68%, 68.5%, 69%, 69.5% or about 70%. In some aspects, the dough may contain dry mix in a range where the lower limit may be from any one of about 60%, 60.5%, 61%, 61.5%, 62%, 62.5%, 63%, 63.5,%, 64%, 64.5%, 65%, 65.5%, 66%, 66.5%, 67% 67.5%, 68%, 68.5%, 69%, or about 69.5% while the upper limit may be from any one of about 60.5%, 61%, 61.5%, 62%, 62.5%, 63.5,%, 64%, 64.5%, 65%, 65.5%, 66%, 66.5%, 67% 67.5%, 68%, 68.5%, 69%, 69.5%, or about 70%, or any range that can be created from these values.

With these ranges and the above description of the dry mix in mind, the skilled artisan can determine the amount of each of the starch base ingredient(s), vegetable substrate(s), whole grain ingredient(s), and optional additives that may be present in the dough.

Regarding the moisture content, the dough will contain from about 30% to about 40%, or from about 30%, 30.5%, 31%, 31.5%, 32.0%, 32.5%, 33.0%, 33.0%, 33.5%, 34%, 34.5%, 35%, 35.5%, 36%, 36.5%, 37%, 37.5%, 38%, 38.5%, 39%, 39.5% or about 40% moisture. In some aspects, the dough may contain moisture in a range where the lower limit may be from any one of about 31%, 31.5%, 32.0%, 32.5%, 33.0%, 33.0%, 33.5%, 34%, 34.5%, 35%, 35.5%, 36%, 36.5%, 37%, 37.5%, 38%, 38.5%, 39%, or about 39.5% while the upper limit may be from any one of about 30.5%, 31%, 31.5%, 32.0%, 32.5%, 33.0%, 33.0%, 33.5%, 34%, 34.5%, 35%, 35.5%, 36.5%, 37%, 37.5%, 38%, 38.5%, 39%, 39.5%, or about 40%. When the dough contains a moisture content that is outside of the above ranges, it is has been found that the resulting snack product is unsuitable. In some instances, when the moisture content is outside the above ranges, the resulting snack product does not possess the desired bulk density range, as further discussed below.

Following preconditioning, the dough is subjected to extruding by introducing (in some instances, immediately after formation of the dough) the dough into an extruder, which may be a single screw or a multi-screw extruder that is capable of delivering a suitable mechanical energy to achieve the desired work to the dough. In at least one embodiment, the delivered mechanical energy is in the ranges of about 50 to about 75 W-h/kg dough, or from about 50, 51, 52, 53, 54, 55, 56, 57, 58, 59, 60, 61, 62, 63, 64, 65, 66, 67, 68, 69, 70, 71, 72, 73, 74, or about 75 W-h/kg dough, or any range that can be created by the previous individual numbers. The extruder may be configured with multiple zones such that the temperature at the beginning or entrance of the extruder is between about 70° C. and 90° C. and the temperature at the end or output of the extruder ranges from about 80° C. to about 120° C. The residence time may range from about 1 second to about 600 seconds.

The extruder is configured with a die head (die slot) to form a continuous sheet having a width between about 2 in. to about 24 in., or from about 2, 3, 4, 5, 6, 7, 8, 9, 10, 11, 12, 13, 14, 15, 16, 17, 18, 19, 20, 21, 22, 23, or about 24 in. In addition, the continuous sheet may have a thickness between about 0.2 mm to about 2 mm, or about 0.3, 0.4, 0.5, 0.6, 0.7, 0.8, 0.9, 1.0, 1.1, 1.2, 1.3, 11.4, 1.5, 1.6, 1.7, 1.8, 1.9, or about 2.0 mm. In commercial practice there may be more than a single extruder such that more than a single sheet is simultaneously produced.

The extruded sheet or sheets may then be optionally perforated to create holes in the sheets which will then be present in the resulting snack. In this regard, as will become evident, one or more of the extruded sheets may be perforated.

After perforating, the sheets are tempered to a temperature between about 25° C. and about 35° C. The tempering temperature may be about 25° C., 26° C., 27° C., 28° C., 29° C., 30° C., 31° C., 32° C., 33° C., 34° C., or about 35° C. After tempering, two or more sheets may be optionally joined and then cut 22 to form individual snack sized pieces or clusters of individual snack sized pieces. In one instance two sheets are joined. It is contemplated that more than two sheets may be joined such as, for example, three, four, or more. Additionally or alternatively, one or more or all of the layers may include perforations (i.e., holes passing through one or more of the layers).

Thereafter, the individual snack sized pieces and clusters of individual snack-sized pieces are dehydrated to reduce the moisture content to a range between about 8% to about 15% and produce dried snack-sized pieces. The moisture content after dehydration may be about 8%, 9%, 10%, 11%, 12%, 13%, 14%, or 15% or any range that can be created from these values. The dehydration may be accomplished in any known manner such as by shaker driers, multistage driers, and a combination of each.

The dried snack-sized pieces may then be fried in oil. Where the sheets are joined as described above, the frying will cause a central portion of the individual snack sized piece to separate from each other and to form a three dimensional snack product. The individual snack sized pieces may be fried in any suitable vegetable oil such as corn, canola, safflower, sunflower, and the like. General frying conditions are known to those skilled in the art and need not be elaborated.

After frying, the produced snack product pieces may be seasoned by application of one or more seasonings or flavorings applied to the surfaces of the individual snack product pieces in a known manner. It will be appreciated that any number of seasoning or flavoring particles or compositions may be applied. By way of example and without intending to limit the scope of this disclosure, the additional seasoning or flavoring may comprise sodium chloride, table salt, kosher salt, sea salt, pepper, paprika, dill, cinnamon, sugar, cardamom, ginger, mustard, parsley, sage, thyme, ranch, barbeque, cheese, vinegar, honey, sour cream, onion, jalapeno, chile limon, limon, dill pickle, adobadas, and any combination thereof.

In some embodiments, seasoning or flavoring may be added in amounts of up to about 10% per individual snack sized piece, depending on the type of flavor profile desired. In this regard, the seasoning or flavoring may be present on the snack product in an amount ranging from about 0.1% to about 10%, or about 0.1%. 0.2%, 0.3%. 0.4%, 0.5%, 0.6%, 0.7%, 0.8%, 0.9% 1%, 2%, 3%, 4%, 5%, 6%, 7%, 8%, 9%, or about 10%. In some aspects, the seasoning or flavoring may be present on the snack product in a range where the lower limit may be from any one of about 0.1%. 0.2%, 0.3%. 0.4%, 0.5%, 0.6%, 0.7%, 0.8%, 0.9% 1%, 2%, 3%, 4%, 5%, 6%, 7%, 8%, or about 9%, while the upper limit may be from any one of about 0.2%, 0.3%. 0.4%, 0.5%, 0.6%, 0.7%, 0.8%, 0.9% 2%, 3%, 4%, 5%, 6%, 7%, 8%, 9%, 6%, 7%, 8%, 9%, or about 10%.

Thereafter, the snack product pieces (whether seasoned or not) are packaged into a suitable package. The package may contain only single type (e.g., a single color) of snack product or may contain more than one type (e., more than a single color) of snack product.

### Resulting Snack Product

The resulting snack product may contain a starch base, vegetable substrate(s), whole grain ingredient(s), optional additives, and from about 1% to about 4% moisture, with the remaining being oil, which typically is present in an amount less than about 35%, or about 30% or less. As will be evident from the foregoing description, the resulting snack product may be the result of a minor-starch formulation or a major-starch formulation.

With this in mind, where the resulting snack product is formed with a minor starch base formulation, the resulting snack product may contain from about 10% to about 25% of a starch base ingredient, which as explained above may include a combination of potato starch and one or more of tapioca starch and corn starch. To this end, the minor starch formulation comprises, consists essentially of, or consists of a mixture of potato starch and one or more of tapioca starch and corn starch. In the aggregate, the starch base ingredient may be present in the resulting snack product in an amount of about 10%, 11%, 12%, 13%, 14%, 15%, 16%, 17%, 18%, 19%, 20%, 21%, 22%, 23%, 24%, or about 25%. In this regard, the starch base ingredient(s) may be present in the snack product in a range where the lower limit may be from any one of about 10%, 11%, 12%, 13%, 14%, 15%, 16%, 17%, 18%, 19%, 20%, 21%, 22%, 23%, or about 24%, while the upper limit may be from any one of about 11%, 12%, 13%, 14%, 15%, 16%, 17%, 18%, 19%, 20%, 21%, 22%, 23%, 24%, or about 25%.

In some aspects, the starch base comprises, consists essentially of, or consists of a mixture of potato starch and one of tapioca starch or corn starch. The potato starch and either the tapioca starch or corn starch may be present in the snack product in a ratio of about 1:1 to about 3:1 or about 2:1. To this end, the potato starch may be present in the snack product in amounts ranging from about 5% to about 15%, or about 5%, 6%, 7%, 8%, 9%, 10%, 11%, 12%, 13%, 14%, or about 15%. In some embodiments, the potato starch may be present in the snack product in a range where the lower limit may be from any one of about 5%, 6%, 7%, 8%, 9%, 10%, 11%, 12%, 13%, or about 14%, while the upper limit may be from any one of about 6%, 7%, 8%, 9%, 10%, 11%, 12%, 13%, 14%, or about 15%. Also, in these aspects, the tapioca starch or the corn starch may be included in the snack product in amounts ranging from about 1% to about 10%, or about 1%, 2%, 3%, 4%, 5%, 6%, 7%, 8%, 9%, or about 10%. In some embodiments, tapioca starch or the corn starch may be present in the snack product in a range where the lower limit may be from any one of about 1%, 2%, 3%, 4%, 5%, 6%, 7%, 8%, or about 9%, while the upper limit may be from any one of about 2%, 3,%, 4%, 5%, 6%, 7%, 8%, 9%, or about 10%.

In some aspects, the starch base comprises, consists essentially of, or consists of a mixture of potato starch, tapioca starch, and corn starch. The potato starch and the tapioca starch may be present in the snack product in a ratio of about 1:1. To this end, the potato starch and tapioca starch may be included in the snack product in amounts ranging from about 5% to about 15%, or about 5%, 6%, 7%, 8%, 9%, 10%, 11%, 12%, 13%, 14%, or about 15%. In some embodiments, the potato starch and the tapioca starch may be present in the snack product in a range where the lower limit may be from any one of about 5%, 6%, 7%, 8%, 9%, 10%, 11%, 12%, 13%, or about 14%, while the upper limit may be from any one of about 6%, 7%, 8%, 9%, 10%, 11%, 12%, 13%, 14%, or about 15%. Also, in these aspects, the corn starch may be included in the snack product in amounts such that a ratio of potato starch to tapioca starch to corn starch is about 1:1:0.67. To that end, the corn starch may be provided in the snack product in amounts ranging from about % to about 10%, or about 1%, 2%, 3%, 4%, 5%, 6%, 7%, 8%, 9%, or about 10%. In some embodiments, the corn starch may be present in the snack product in a range where the lower limit may be from any one of about 1%, 2%, 3%, 4%, 5%, 6%, 7%, 8%, or about 9%, while the upper limit may be from any one of about 2%, 3,%, 4%, 5%, 6%, 7%, 8%, 9%, or about 10%.

Alternatively, where the resulting snack product is the result of a major starch formulation, the resulting snack product may contain from about 30% to about 40% of a starch base ingredient, which as noted above may comprise, consist essentially of, or consist of potato starch. The starch base ingredient may be present in the resulting snack product in an amount of about 30%, 31%, 32%, 33%, 34%, 35%, 36%, 37%, 38%, 39%, or about 40%. In this regard, the starch base ingredient may be present in the snack product in a range where the lower limit may be from any one of about 30%, 31%, 32%, 33%, 34%, 35%, 36%, 37%, 38%, or about 39%, while the upper limit may be from any one of about 31%, 32%, 33%, 34%, 35%, 36%, 37%, 38%, 39%, or about 40%. In some instances, the snack product formed with the major starch formulation comprises, consists essentially of, or consists of potato starch.

The vegetable substrate may be present in the snack product in an amount from about 5% to about 20%. The vegetable substrate may be present in the snack product in an amount of about 5%, 6%, 7%, 8%, 9%, 10%, 11%, 12%, 13%, 14%, 15%, 16%, 17%, 18%, 19%, 20%. In this regard, the vegetable substrate may be present in the in the snack product in a range where the lower limit may be from any one of about 5%, 6%, 7%, 8%, 9%, 10%, 11%, 12%, 13%, 14%, 15%, 16%, 17%, 18%, or about 19%, while the upper limit may be from any one of about 6%, 7%, 8%, 9%, 10%, 11%, 12%, 13%, 14%, 15%, 16%, 17%, 18%, 19%, or about 20%.

The whole grain ingredient(s) may be present in the snack product in an amount ranging from about 15% to about 45%. To that end, if the snack product is formulated with a minor starch base formulation, the whole grain ingredient(s) may be present in an amount from about 30% to about 45%. In this regard, the whole grain ingredient(s) may be present in an amount of about 30%, 31%, 32%, 33%, 34%, 35%, 36%, 37%, 38%, 39%, 40%, 41%, 42%, 43%, 44%, 45%. In some instances, the whole grain ingredient(s) may be present in the in the snack product in a range where the lower limit may be from any one of about 30%, 31%, 32%, 33%, 34%, 35%, 36%, 37%, 38%, 39%, 40%, 41%, 42%, 43%, or about 44%, while the upper limit may be from any one of about 31%, 32%, 33%, 34%, 35%, 36%, 37%, 38%, 39%, 40%, 41%, 42%, 43%, 44%, or about 45%.

Alternatively, if the if the snack product is formulated with a major starch base formulation, the whole grain ingredient(s) may be present in an amount from about 15% to about 30%. In this regard, the whole grain ingredient(s) may be present in an amount of about 15%, 16%, 17%, 18%, 19%, 20%, 21%, 22%, 23%, 24%, 25%, 26%, 27%, 28%, 29%, or about 30%. In some instances, the whole grain ingredient(s) may be present in the in the snack product in a range where the lower limit may be from any one of about 15%, 16%, 17%, 18%, 19%, 20%, 21%, 22%, 23%, 24%, 25%, 26%, 27%, 28%, 29%, or about 44%, while the upper limit may be from any one of about 16%, 17%, 18%, 19%, 20%, 21%, 22%, 23%, 24%, 25%, 26%, 27%, 28%, 29%, or about 30%.

The snack product may contain optional additives in amounts up to about 5%. The additives may be one or more of the additives noted above with respect to the preparation of the dry mix. Further, the snack product may contain one or more topical seasonings When applied, the seasoning or seasonings may comprise from about 0.5% to about 10%, in the aggregate, of the snack product.

In addition, the resulting snack product may provide 10% or more vegetables other than potatoes and corn while providing whole grain ingredients in amounts from about 15% to about 45%.

The snack product may have a bulk density between about 50 g/L to about 84 g/L. In some embodiments such as in an unseasoned state, i.e., prior to application of seasoning, the snack product may have a bulk density between about 50 g/L to about 72 g/L. In these instances, the snack product may have a bulk density from about 50, 51, 52, 53, 54, 55, 56, 57, 58, 59, 60, 61, 62, 63, 64, 65, 66, 67, 68, 69, 70, 71, or about 72 g/L. In some aspects, the unseasoned snack product be in a range where the lower limit may be from any one of about 50, 51, 52, 53, 54, 55, 56, 57, 58, 59, 60, 61, 62, 63, 64, 65, 66, 67, 68, 69, 70, 71 g/L, while the upper limit may be from any one of about 51, 52, 53, 54, 55, 56, 57, 58, 59, 60, 61, 62, 63, 64, 65, 66, 67, 68, 69, 70, 71 or about 72 g/L.

In other aspects, a seasoned snack product may have a bulk density between about 50 g/L to about 84 g/L. In these instances, the seasoned snack product may have a bulk density from about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80 81, 82, 83, or about 84 g/L. In some aspects, the seasoned snack product be in a range where the lower limit may be from any one of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80 81, 82, 83 g/L, while the upper limit may be from any one of about 51, 52, 53, 54, 55, 56, 57, 58, 59, 60, 61, 62, 63, 64, 65, 66, 67, 68, 69, 70, 71, 72, 73, 74, 75, 76, 77, 78, 79, 80 81, 82, 83, or about 84 g/L.

Where an embodiment is described as comprising some element or group of elements, additional embodiments can consist essentially of or consist of the element or group of elements. Also, although the open-ended term “comprises” is generally used in this description, additional embodiments can be formed by substituting the terms “consisting essentially of” or “consisting of.”

Additionally, when a range for a particular variable is given for an embodiment, an additional embodiment can be created using a subrange or individual values that are contained within the range. Moreover, when a value, values, a range, or ranges for a particular variable are given for one or more embodiments, an additional embodiment can be created by forming a new range whose endpoints are selected from any expressly listed value, any value between expressly listed values, and any value contained in a listed range. For example, if the application were to disclose an embodiment in which a variable is 1 and a second embodiment in which the variable is 3-5, a third embodiment can be created in which the variable is 1.31-4.23. Similarly, a fourth embodiment can be created in which the variable is 1-5.

While the invention has been described in terms of specific or particular embodiments, it should be apparent that alternatives could be adopted by one skilled in the art. In addition, the invention encompasses additional or alternative embodiments in which one or more features or aspects of a particular embodiment could be eliminated or two or more features or aspects of different disclosed embodiments could be combined. Accordingly, it should be understood that the invention is not necessarily limited to any embodiment described herein or illustrated in the drawings. It should also be understood that the purpose of the above detailed description and the phraseology and terminology employed therein is to describe the illustrated embodiments, and not necessarily to serve as limitations to the scope of the invention. Finally, while the appended claims recite certain aspects believed to be associated with the invention, they do not necessarily serve as limitations to the scope of the invention.

1. A snack product comprising:
from about 10% to about 40% of a starch base,
from about 5% to about 20% of one or more vegetable substrates,
from about 10% to about 45% one or more whole grain ingredients, and
from about 1% to about 4% moisture;
wherein the snack product provides 10% or more of vegetable material exclusive of potato and corn, at least 10% whole grains and has a bulk density between about 50 g/L to about 84 g/L.

2. The snack product of claim 1 wherein the starch base is free of gluten.

3. The snack product of claim 1 wherein the starch base includes one or more of a potato starch, tapioca starch, and corn starch.

4. The snack product of claim 3 wherein the starch base consists of potato starch.

5. The snack product of claim 3 wherein the starch base comprises potato starch and tapioca starch or corn starch, wherein a ratio of potato starch to the tapioca starch or corn starch is about 2:1.

6. The snack product of claim 3 wherein the starch base consists of potato starch, tapioca starch, and corn starch, wherein a ratio of potato starch to tapioca starch to corn starch is about 1:1:0.67.

7. The snack product of claim 3 wherein the starch base is present in the snack product in an amount from about 30% to about 40%.

8. The snack product of claim 1 wherein the whole vegetable flour is selected from legumes, pulses, and vegetables other than potatoes and corn and is free of decorticated and pre-cooked flours.

9. The snack product of claim 7 wherein the one or more whole grain ingredients are present in the snack product in an amount between about 10% to about 30%.

10. The snack product of claim 9 wherein the one or more whole grain ingredients do not contain gluten.

11. The snack product of claim 9 wherein the one or more whole grain ingredients comprise whole rice flour and whole corn flour.

12. The snack product of claim 11 wherein the whole rice flour and whole corn flour are present in a ratio of about 1:1.

13. The snack product of claim 1 further comprising additives that include processing aids, flavorants, colorants present in individual amounts from about 0.05% to about 5%.

14. A method of making a snack product comprising:
a. providing a dry mix that includes from about 15% to about 60% of a starch base ingredient, from about 5% to about 25% of one or more vegetable substrates, wherein the vegetable substrate is from a source other than potato or corn, from about 10% to about 60% of one or more whole grain ingredients, and less than about 5% of additives;
b. hydrating the dry mix to form a dough containing from 30% to 40% of moisture;
C. introducing the dough to an extruder and applying a specific mechanical energy to the dough;
d. extruding the dough through a die slot to form a continuous sheet having a width between about 2 in. and about 24 in. and having a thickness in the range of about 0.2 mm to about 2.0 mm
e. cutting the sheet to form individual snack sized pieces and/or clusters of individual snack-sized pieces;
f. dehydrating the individual snack-sized pieces to a moisture content between about 8% to about 15%; and
g. frying the individual snack sized pieces to form the snack product having 10% or more vegetables, exclusive of potato and corn, at least 10% whole grains and a bulk density between about 50 g/L to about 84 g/L.

15. The method of claim 14 further comprising, prior to cutting, perforating the sheet and tempering the perforated sheet to a temperature within a range between about 25° C. to about 35° C.

16. The method of claim 15 further comprising, after tempering, joining one or more sheets prior to cutting such that after frying a three dimensional snack product is created.
